(19) United States
(12) Patent Application Publication
(10) Pub. No.: US 2009/0302190 A1
(43) Pub. Date: Dec. 10, 2009

(54) CHIP HOLDER, FLUIDIC SYSTEM AND CHIP HOLDER SYSTEM

(75) Inventors: Hoc Khiem Trieu, Kamp-Lintfort (DE); Johann Slotkowski, Herdecke (DE); Robert Klieber, Dortmund (DE); Jan Cornelis Maria Van Hest, Nijmegen (NL); Kaspar Koch, Nijmegen (NL); Floris Petrus Johannes Theodorus Rutjes, Wijchen (NL); Pieter Nieuwland, Nijmegen (NL); Peter Wiebke, Duisburg (DE)

Correspondence Address: SCHOPPE, ZIMMERMANN , STOCKELER & ZINKLER;C/O KEATING & BENNETT, LLP, 1800 Alexander Bell Drive, SUITE 200, Reston, VA, 20191, US

(73) Assignees: Fraunhofer-Gesellschaft zur Foerderung der angewandten Forschung e.V., Munich (DE); NIJMEGEN UNIVERSITY, Nijmegen (NL)

(21) Appl. No.: 12/447,019

(22) PCT Filed: Oct. 25, 2006
(86) PCT No.: PCT/EP2006/010299

§ 371 Date: Aug. 18, 2009

(51) Int. Cl. F16M 13/00

(52) U.S. Cl. 248/683; 248/682

(57) ABSTRACT

A chip holder for holding a fluidic chip and for providing a fluid connection thereto has a guide adapted such that the fluidic chip can be slid into the chip holder in a guiding direction. The chip holder further has a fastener adapted to press a fluidic connection toward the fluidic chip, such that the fluidic chip is fixed within the chip holder. The guide and the fastener are adapted such that the guiding direction and the direction in which the fluidic connection is pressed exhibit an angle in the range between 45° and 135°, including 45° and 135°. A fluidic system has a chip holder and a fluidic chip inserted therein. A chip holder system has a chip holder and an extension module attached thereto such that the extension module is in contact with the fluidic chip, when the fluidic chip is inserted in the chip holder.

### BACKGROUND OF THE INVENTION

The present application is generally related to a chip holder, a fluidic system and a chip holder system. In particular the present invention is related to a slide-in chip holder with modular setup.

In the recent years, fluidic and microfluidic systems have become more and more important, allowing to perform chemical and/or biological methods on a mesoscopic or microscopic scale. An advantage of fluidic or microfluidic systems is the fact that the reactions can be performed in a fluidic or microfluidic chip that may be produced as a cheap, disposable component. In this way, contaminations between different reaction setups can be avoided simply by changing the fluidic chip in which the reactions took place.

It should be noted that in the following, the term “fluidic chip” designates any chip containing fluid channels, independent of the size of the chip. However, in an embodiment a microfluidic chip is used, the microfluidic chip comprising fluid channels of sub-millimeter scale. In another embodiment, the fluidic chip may comprise fluid channels of a millimeter scale or even larger fluid channels.

Moreover, it should be noted that in the following the terms “fluidic connection” or “fluid connection” designates both a macroscopic fluid connection (e.g. fluid connections having a diameter of more than 1 millimeter) or a microfluidic connection (e.g. a fluid connection having a diameter of less than 1 millimeter).

However, using a fluidic chip typically necessitates using a chip holder in which the fluidic chip is fixed and which further provides fluidic connections to the fluidic chip. A number of setups for a chip holder for a fluidic chip have been proposed so far. It has been found that connecting fluidic chips to macroscopic tubes or auxiliary devices such as pumps and analysis tools is not trivial. For example, in [1], several one-touch fluidic tube connectors for fluidic devices have been described. However, making use of the fluidic tube connector described in [1], changing the chip still brings along a comparatively high amount of effort.

Moreover, it should be noted that almost all literature examples of “chip-to-world” interfaces are only suitable for low-pressure applications. For example, [2] and [3] describe a socket for fluidic prototype development and a socket with build-in valves for the interconnection of fluidic chips to macroconstituents, respectively. [2] describes a socket for a microchip to access the outside world by means of fluids, data and energy supply. The socket further provides process observability. The socket has twenty channels for the input and output of liquids or gases, as well as compressed air or vacuum lines for pneumatic power lines. It also contains forty-two pins for electrical signals and power. All the connections are designed in a planar configuration.

[3] describes a prototype for a standard connector between a microfluidic chip and the macroworld. The prototype demonstrates a socket for a microchip to access the outside world by means of fluids, data signals and energy supply. The socket has a build-in valve for each flow channel. It also contains twenty-eight pins for the connection of electrical signals and power. According to [3], silicon tubes serves as O-rings. Thus, manually handling individual O-rings is not required.

Moreover, there is a high-pressure chip holder known in literature, but the design is complex and not suitable for modular addition of components [4].

However, it has been shown that some problems of the known chip holders arise from an insufficient fluidic connection. In order to avoid these problems, some solutions incorporate the usage of glue or other binding substances. This offers a permanent connection between a microfluidic device and fluidic tubing [5]. However, besides the obvious inflexibility, another drawback is that the glue used should be resistant to all fluids flowing through the connection.

### SUMMARY

According to an embodiment, a chip holder for holding a fluidic chip and for providing a fluid connection to the fluidic chip may have: a guide, the guide being adapted such that the fluidic chip can be slid into the chip holder in a guiding direction; and a fastener, the fastener being adapted to press a fluidic connection toward the fluidic chip, such that the fluidic chip is fixed within the chip holder, wherein the guide and the fastener are adapted such that the guiding direction and the direction, in which the fluidic connection is pressed, exhibit an angle in the range between 45° and 135°, including 45° and 135°, wherein the fastener has a threaded hole and a threaded bolt or threaded screw, wherein the threaded bolt or threaded screw has a fluid guide structure for guiding a fluid along an axis of the threaded bolt or threaded screw, wherein one end surface of the threaded bolt or threaded screw is adapted to press a seal toward the fluidic chip, and wherein the seal is adapted such that a sealed fluid connection between the fluid guide structure and a fluid channel of the fluidic chip is established when the fastener presses the seal toward the fluidic chip.

According to another embodiment, a chip holder for holding a fluidic chip and for providing a fluidic connection to the fluidic chip may have: a holder for holding the chip within the chip holder; an opening to provide access to a portion of the fluidic chip where no fluidic connections are present, when the fluidic chip is inserted in the chip holder; and a module fastener for detachably fastening an extension module to the chip holder, such that the extension module is in an optical, mechanical, electrical, magnetic, thermal or fluidic contact with the accessible portion of the fluidic chip, when the extension module is fastened to the chip holder, and when the fluidic chip is inserted in the chip holder; wherein the holder has a guide and a fastener; wherein the guide is adapted such that the fluidic chip can be slid into the chip holder in a guiding direction; and wherein the fastener is adapted to press a fluidic connection toward the fluidic chip, such that the fluidic chip is fixed within the chip holder, wherein the guide and the fastener are adapted such that the guiding direction and the direction, in which the fluidic connection is pressed, exhibit an angle in the range between 45° and 135°, including 45° and 135°, wherein the fastener has a threaded hole and a threaded bolt or threaded screw, wherein the threaded bolt or threaded screw has a fluid guide structure for guiding a fluid along an axis of the threaded bolt or threaded screw, wherein one end surface of the threaded bolt or threaded screw is adapted to press a seal toward the fluidic chip, and wherein the seal is adapted such that a sealed fluid connection between the fluid guide structure and a fluid channel of the fluidic chip is established when the fastener presses the seal toward the fluidic chip.

According to another embodiment, a chip holder for holding a fluidic chip and for providing a fluid connection to the fluidic chip may have: a guide, the guide being adapted such that the fluidic chip can be slid into the chip holder in a guiding direction, wherein the guide has two recesses; and a fastener, the fastener being adapted to press a fluidic connection toward the fluidic chip, such that the fluidic chip is fixed within the chip holder, the fastener having holes, wherein the guide and the fastener are adapted such that the guiding direction and the direction, in which the fluidic connection is pressed, exhibit an angle in the range between 45° and 135°, including 45° and 135°; wherein the chip holder has a first carrying structure mechanically connecting pieces of material carrying the recesses, and a second carrying structure mechanically connecting the piece of material in which the first recess is formed with the piece of material in which the second recess is formed; wherein the carrying structures have the holes, into which the fluidic connections can be inserted; wherein the chip holder has an exemption arranged between the first carrying structure and the second carrying structure and allowing for an access to the fluidic chip when the fluidic chip is inserted into the chip holder; wherein the chip holder has a module fastener for detachably fastening an extension module to the chip holder in the region of the exemption, such that the extension module is in an optical, mechanical, electrical, magnetic, thermal or fluidic contact with the fluidic chip, when the extension module is fastened to the chip holder and the fluidic chip is inserted in the chip holder.

According to another embodiment, a chip holder system may have a chip holder for holding a fluidic chip and for providing a fluid connection to the fluidic chip, wherein the chip holder may have: a guide, the guide being adapted such that the fluidic chip can be slid into the chip holder in a guiding direction, wherein the guide has two recesses; and a fastener, the fastener being adapted to press a fluidic connection toward the fluidic chip, such that the fluidic chip is fixed within the chip holder, the fastener having holes, wherein the guide and the fastener are adapted such that the guiding direction and the direction, in which the fluidic connection is pressed, exhibit an angle in the range between 45° and 135°, including 45° and 135°; wherein the chip holder has a first carrying structure mechanically connecting pieces of material carrying the recesses, and a second carrying structure mechanically connecting the piece of material in which the first recess is formed with the piece of material in which the second recess is formed; wherein the carrying structures have the holes, into which the fluidic connections can be inserted; wherein the chip holder has an exemption arranged between the first carrying structure and the second carrying structure and allowing for an access to the fluidic chip when the fluidic chip is inserted into the chip holder; wherein the chip holder has a module fastener for detachably fastening an extension module to the chip holder in the region of the exemption, such that the extension module is in an optical, mechanical, electrical, magnetic, thermal or fluidic contact with the fluidic chip, when the extension module is fastened to the chip holder and the fluidic chip is inserted in the chip holder; and an extension module attached to the chip holder such that the extension module is in contact with the fluidic chip, when the fluidic chip is inserted in the chip holder.

According to another embodiment, a chip holder for holding a fluidic chip and for providing a fluidic connection to the fluidic chip may have: a holder for pressing fluidic connections toward the fluidic chip to hold the chip within the chip holder; an opening arranged between a first holder and a second holder to provide access to a middle portion of the fluidic chip where no fluidic connections are present, when the fluidic chip is inserted in the chip holder; and a module fastener for detachably fastening an extension module to the chip holder in a region of the opening, such that the extension module is in an optical, mechanical, electrical, magnetic, thermal or fluidic contact with the accessible portion of the fluidic chip, when the extension module is fastened to the chip holder, and when the fluidic chip is inserted in the chip holder.

The present invention creates a chip holder for holding a fluidic chip and for providing a fluid connection to the fluidic chip. The chip holder comprises a guide, the guide being adapted such that the fluidic chip can be slid into the chip holder in a guiding direction. Moreover, the chip holder comprises fastening means, the fastening means being adapted to press a fluidic connection toward the fluidic chip, such that the fluidic chip is fixed within the chip holder. The guide and the fastening means are adapted such that the guide direction and the direction, in which the fluidic connection is pressed, exhibit an angle in the range between 45° and 135°, including 45° and 135°.

It is the key idea of the present invention that a connection between a fluidic chip and a fluidic component outside the fluidic chip can be established in a particularly fast and reliable way, if a chip holder is adapted such that pressing the fluidic connection toward the fluidic chip at the same fixes the chip within the chip holder. In other words, fixing the fluidic chip in the chip holder is done at the same time when a reliable connection to the fluidic chip is established.

Moreover, it has been recognized that the reliability of the fluidic connection is particularly high, if the guiding direction, in which the chip can be slid into the chip holder, is approximately orthogonal to the direction in which the fluidic connection is pressed (i.e. if the angle between said directions is within a range of 45° to 135°). On the one hand, an efficient fastening of the chip can be achieved by pressing the fluidic connection toward the chip in a direction that is approximately orthogonal to the sliding direction. Moreover, and more importantly, when the chip is slid into the chip holder in a direction that is approximately orthogonal to the direction in which the fluidic connection is pressed, the fluidic connection needs to be moved by only a very small distance, as the fluidic connection, once loosened sufficiently not to fix the fluidic chip, is not located in the path along which the chip is slid into the chip holder or out of the chip holder. In other words, due to the fact that the direction in which the fluidic connection is pressed toward the chip is approximately perpendicular to the direction in which the fluidic chip can be slid into the chip holder (or out of the chip holder), it is sufficient to remove the fluidic connection so far from the chip that it does not press on the chip any more when a used fluidic chip is to be removed from the chip holder, or when a new fluidic chip is to be inserted into the chip holder. The minimal motion, which is needed to fasten the fluidic connection, so that the fluidic connection does no longer press toward the chip, avoids an unnecessarily strong motion of the tubes or pipes that constitute the external fluidic connection of the fluidic chip. Thus, an excessive bending of the external fluidic pipes or tubes can be avoided. Rather, only a minimum bending of the external fluidic pipes or tubes is needed in view of the present invention.

Thus, the inventive chip holder brings along a large number of advantages. On the one hand, inserting the fluidic chip into the chip holder is easily possible even by low-qualified staff if the fluidic chip is guided into the chip holder. Moreover, fastening of the fluidic chip is performed at the same time when making the fluidic connections. This reduces the time needed to change the chip drastically when compared to conventional chip holders, while still a very tight fastening of both the fluidic chip itself and the fluidic connections can be achieved. As a consequence, a fast change of a chip is possible even if the chip is operating under high-pressure conditions (i.e. high pressure is applied to the fluidic connection).

Consequently, the present invention provides fixation and high-pressure connection of the fluidic chip in one simple solution, minimizing the amount of adjustment needed when the chip is set up for usage.

In an embodiment, the fastening means is adapted to detachably press a seal toward the fluidic chip, wherein the seal is adapted to avoid a leakage of a fluid connection between a pipe and a fluid channel within the fluidic chip, the pipe connecting the fluidic chip with a fluidic system external to the fluidic chip. It has been shown that a particularly simple and efficient solution can be achieved if the pressure is applied to the fluidic chip via a seal. A seal (e.g. a gasket) is typically a slightly deformable material. Thus, applying the pressure to the fluidic chip via the seal brings along the advantage that a risk of damaging the fluidic chip is reduced. Rather, the seal distributes the force applied to the fluidic chip evenly. Moreover, at the same time when pressing the seal toward the fluidic chip, the fluidic connection is sealed, minimizing the risk of leakage. Moreover, a total pressure applied to the fluidic chip is minimized, as the need for separate fluidic chip fastening means and fluidic connection fastening means is eliminated. Rather, by pressing the seal toward the fluidic chip, the task of fixing the fluidic chip within the chip holder and establishing a leakage-free fluidic connection to the chip is performed at the same time.

In another embodiment, the fastening means comprises a threaded hole and a threaded bolt or a threaded screw. The threaded bolt or threaded screw comprises a fluid guide structure (i.e. a hole, or a capillary inserted into a hole), which is adapted to guide a fluid along an axis of the threaded bolt or threaded screw. Moreover, one of the end surfaces of the threaded screw or threaded bolt is advantageously adapted to press the seal toward the fluidic chip. Besides, the seal is adapted such that a sealed fluid connection between the fluid guide structure of the threaded screw or threaded bolt, and the fluid channel of the fluidic chip is established when the fastening means presses the seal toward the fluidic chip. In other words, a threaded bolt comprises a fluid guide structure capable of guiding a fluid in a direction along the axis of the threaded bolt or threaded screw. Moreover, the fluid guide within the threaded bolt or threaded screw coupled to a fluid channel of the fluidic chip through an opening in the seal. Thus, the threaded bolt or threaded screw has the double function of applying a pressure to the seal (in order to avoid leakage, and in order to fix the fluidic chip) and to guide a fluid. Consequently, a very efficient and low-cost implementation of the chip holder can be achieved.

In another embodiment, the fluidic connection comprises a seal having a conical form, such that a diameter of the seal decreases in the direction toward the fluidic chip. Moreover, the seal is adapted to be inserted, at least partially, into a conical opening of the fluidic chip. This embodiment brings along the advantage that the seal actually enters into the fluidic chip. Thus, a particularly good fixation of the fluidic chip can be achieved. Also, due to the conical shape of the seal, the fluidic chip is automatically aligned as soon as the conical seal is pressed toward the fluidic chip, provided that the position of the conical seal approximates the position of the opening in the fluidic chip. In other words, if the fluidic chip is slightly misaligned (i.e. by less than half the maximum diameter of a fluid opening), pushing the conical seal toward the fluidic chip will result in an automatic correction of the alignment. Thus, the more the conical seal is pressed toward the fluidic chip, the more the fluidic chip will move to its intended position. Thus, by using a seal having a conical shape, a particularly advantageous procedure of inserting and aligning the fluidic chip in the chip holder can be achieved.

In another embodiment, the chip holder further comprises at least one dummy fastening means, the dummy fastening means being adapted to be pressed toward the fluidic chip, such that the fluidic chip is fixed within the chip holder. The dummy fastening means is adapted to be replaceable by the fastening means for pressing the fluidic connection toward the fluidic chip. In other words, the chip holder comprises a dummy fastening means that can be fastened in the same way as the fluidic connection fastening means. Thus, the dummy fastening means can be replaced by a fluidic connection fastening means and vice versa, resulting in a possibility to configure the chip holder in a very flexible way. Thus, whenever a fluidic connection is needed, a fastening means comprising a fluidic connection can be used. On the other hand, whenever fixation is necessitated without the need to have a fluidic connection, a dummy fastening means can be used.

In another embodiment, the chip holder is adapted such that an optical inspection gap remains between a surface of the fluidic chip and the chip holder, when the fluidic chip is inserted into the chip holder. The optical inspection gap is arranged such that the fluidic connection can be inspected visually by an operator when the fluidic chip is inserted in the chip holder. The optical inspection gap allows for a check whether the fluidic connection exhibits any leakage. In case there is a leakage, it can be assumed that the fastening means either needs to be tightened, or replaced.

In an embodiment, the chip holder is adapted to provide access to a middle portion of the fluidic chip, when the fluidic chip is inserted into the chip holder. Having access to the fluidic chip allows applying sensing or actuation operations to the fluidic chip. For example, temperature sensors, heaters, coolers, optical process monitoring devices or other process monitoring or process control devices can be applied. Thus, an optimum result of the process can be achieved.

In another embodiment, the chip holder comprises a module fastening means for detachably fastening an extension module to the chip holder, such that the extension module is in an optical, mechanical, electrical, magnetic, thermal or fluidic contact with the fluidic chip, when the extension module is fastened to the chip holder and the fluidic chip is inserted in the chip holder. Allowing for the fastening of an extension module provides a particularly flexible chip holder allowing for a modular setup. In other words, depending on the type of process or reactions to be performed within the fluidic chip, different process monitoring means or process control means can be attached to the chip holder, being in contact (e.g. in direct mechanical contact, or in optical contact) with the fluidic chip. A flexible configuration of the chip holder helps to minimize costs and allows to apply only those extension modules that are absolutely needed. Also, a single chip holder can be used for different processes, as the extension modules are actually used to reconfigure the chip holder.

In another embodiment, the module fastening means comprises an electrical connector, wherein the electrical connector is adapted to fasten the extension module to the chip holder. Making use of an electrical connecter as a fastening means is another step to minimize the complexity of the chip holder. It has been shown that many extension modules necessitate an electrical connection to provide them with power or to provide a signal connection to input or output signals to or from the extension modules.

Also, in an embodiment, the chip holder comprises electrical wiring adapted to provide power supply or information signal connection to one or more sensors or actuators within the fluidic chip, the chip holder or an extension module attached to the chip holder. Thus, the need for extensive external wiring is eliminated.

In another embodiment, the chip holder comprises a spring-loaded mechanism for locking the fluidic chip within the chip holder. Such an embodiment is particularly advantageous, as a spring-loaded mechanism provides at least a coarse fixation of the fluidic chip within the chip holder. Thus, the spring-loaded mechanism provides fixation of the fluidic chip already before the fastening means are actually fastened. Thus, inserting the chip into the chip holder is facilitated. Moreover, after unfastening the fastening means, the chip will not immediately drop out of the chip holder. Rather, a certain force needs to be applied to the fluidic chip in order to unlock the fluidic chip from the spring-loaded mechanism. Accordingly, a particularly good handling of the fluidic chip, both when inserting the fluidic chip into the chip holder and when taking the fluidic chip out of the chip holder, can be achieved.

Moreover, the present invention comprises a fluidic system. The fluidic system comprises a chip holder as described above and a fluidic chip inserted into the chip holder.

The present invention also comprises a chip holder system. The chip holder system comprises a chip holder as described above and an extension module attached to the fluidic chip holder, such that the extension module is in contact with the fluidic chip, when the fluidic chip is inserted in the chip holder.

In an embodiment, the chip holder comprises an electrical connection means to provide an electrical signal to the extension module. Moreover, the extension module comprises an electrical connection means to receive the electrical signal from the chip holder. The electrical connection means of the chip holder is coupled with the electrical connection means of the extension module, when the extension module is attached to the chip holder. Thus, communication of power and signals between the chip holder and the extension module is achieved.

In another embodiment, the extension module is adapted to be mechanically coupled with a further extension module to form a stack of at least two extension modules. Thus, several extension modules can be applied to the chip holder, allowing for a very flexible configuration of the chip holder.

In another embodiment, the extension module is adapted to route an (electrical, thermal, magnetic, optical or fluidic) signal from a first extension module connection means to a second extension module connection means. The first extension module connection means is adapted to provide an electrical (or optical, or fluidic) connection with the chip holder, and the second extension module connection means is adapted to provide an electrical (or optical, or fluidic) connection with the further extension module. Thus, a quick connection to a stack of extension modules can be provided without the need for any external cabling. Rather, when stacking two extension modules, the connection between the extension modules is automatically established. Moreover, when attaching a first extension module to the chip holder, a connection is also advantageously automatically established. Thus, a particularly easy-to-handle fluidic apparatus is obtained.

It should be noted that the term “fluidic chip” may designate a microfluidic chip in an embodiment of the present invention. However, a macroscopic fluidic chip may also be used with the inventive chip holder.

Moreover, the term “fluidic connection” may designate a microfluidic connection in an embodiment of the present invention. However, the term fluidic connection may also designate a macroscopic fluidic connection.

It should be noted, that the fluidic connection is advantageously a microfluidic connection, if the chip holder is adapted to be used with a microfluidic chip.

### BRIEF DESCRIPTION OF THE DRAWINGS

Embodiments of the present invention will be detailed subsequently referring to the appended drawings, in which:

FIG. 1 shows a schematic representation of the principle of the inventive chip holder;

FIG. 2a shows a three-dimensional representation of an inventive chip holder according to an embodiment of the present invention;

FIG. 2b shows a cross-sectional drawing of the chip holder of FIG. 2a;

FIG. 2c shows a cross-sectional drawing of the chip holder of FIG. 2a, with a fluidic chip being inserted in the chip holder;

FIG. 2d shows another cross-sectional drawing;

FIG. 3 shows a cross-sectional representation of a fluidic connection according to an embodiment of the present invention;

FIG. 4 shows a three-dimensional graphical representation of an assembled chip holder, according to an embodiment of the present invention;

FIG. 5 shows a three-dimensional graphical representation of the individual parts of a disassembled chip holder, according to an embodiment of the present invention; and

FIG. 6 shows a cross-sectional view of a chip holder according to an embodiment of the present invention.

### DETAILED DESCRIPTION OF THE INVENTION

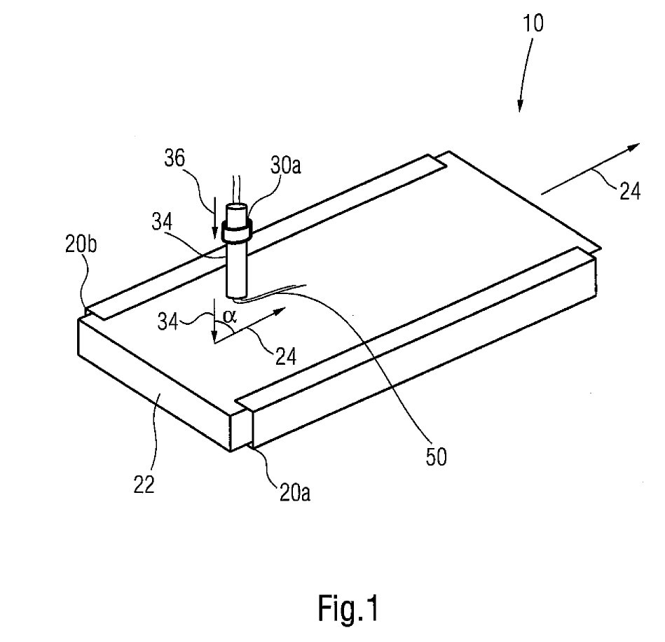

FIG. 1 shows a schematic representation of the inventive chip holder according to an embodiment of the present invention. The schematic representation of FIG. 1 is designated in its entirety with 10. The chip holder 10 comprises a guide 20a, 20b adapted such that the fluidic chip can be slid into the chip holder in a guiding direction 24. The chip holder 10 further comprises a fastening means 30a. The fastening means is adapted to press a fluidic connection 34 toward the fluidic chip 22, such that the fluidic chip is fixed within the chip holder. The guide 20a, 20b and the fastening means 30a are adapted such that the guiding direction 24 and the direction 36, in which the fluidic connection 34 is pressed, exhibit an angle in the range between 45° and 135°, including 45° and 135°. The angle between the guiding direction 24 and the direction 36, in which the fluidic connection 34 is pressed by the fastening means 30a, is designated with α for the sake of visualization.

It should be noted here that the guide 20a, 20b and the fastening means 30a are typically all attached to or part of the chip holder, the body of which is not shown here for the sake of explanation. Moreover, the guide structures 20a, 20b can be replaced by any possible mechanical guide structure that is adapted to guide the fluidic chip into the guiding direction 24 to allow a user to slide the fluidic chip 22 into the chip holder. Moreover, the fastening means 30a represents any means that allow to apply a force to the fluidic connection 34 to press the fluidic connection 34 toward the fluidic chip 22 in a direction as specified above. For example, the fastening means 30a may comprise a combination of a threaded hole and a threaded bolt or a threaded screw. Alternatively, the fastening means may comprise a linear guide (e.g. a hole or any other mechanical guide structure) which allows to guide the fluidic connection in the direction 36 as specified above. Moreover, the fastening means 30a may for example comprise a force applying element, e.g. spring, being adapted to press the fluidic connection 34 toward the fluidic chip 22. The fastening means 30a may also comprise any form of an electrical actuator (e.g. a motor or a magnet) capable of applying a force to the fluidic connection 34.

To summarize the above, any mechanical or electromechanical means may be used to press the fluidic connection 34 toward the fluidic chip 22, provided that the direction 36, in which the pressure is applied, is in agreement with the above definitions.

Following the above structural description of the inventive chip holder, the operation will shortly be described with reference to FIG. 1.

Assuming that no fluidic chip 22 is inserted into the chip holder 10, the fluidic connection 34 is advantageously in a moved-up position, i.e. moved away from the fluidic chip 22. In other words, when there is no fluidic chip 22 inserted in the chip holder, the fluidic connection 34 is advantageously recessed from the slot into which the fluidic chip can be inserted. In other words, the fluidic connection 34 is typically moved in a direction opposite to the direction 36.

Thus, when the fluidic chip 22 is inserted into the chip holder 10, i.e. slid into the chip holder 10 along the guide 20a, 20b, the fluidic connection 34 is advantageously not in contact with the chip. In order to achieve this, it is typically sufficient to recess the fluidic connection 34 by approximately half a millimeter in the direction opposite to the direction 36, i.e. away from the position of the fluidic chip, but the fluidic connection may be recessed more.

As soon as the fluidic chip 22 is placed within the chip holder 10, the fluidic connection 34 is advantageously pressed toward the fluidic chip 22 (i.e. into the direction 36) via fastening the means 30a. Advantageously, before pressing the fluidic connector 34 toward the fluidic chip 22, the fluidic chip 22 is aligned such that the fluidic connector 34 is pressed toward the fluidic chip 22 at the position of a fluidic opening of the fluidic chip 22. Thus, when the fluidic connector 34 is pressed toward the fluidic chip, a fluidic coupling is established between the fluidic connection 34 and a fluid channel 50 within the fluidic chip 22. Moreover, the application of a force (or pressure) to the fluidic chip 22 via the fluidic connection 34 results in a fixation of the fluidic chip 22 within the chip holder 10. For example, if the fluidic chip 22 is pressed into the direction 36, a friction force occurs between the guide 20a, 20b and the fluidic chip 22 (or to be more precise, the friction force is increased due to the application of the pressure in the direction 36). Thus, by pressing the fluidic chip 22 in the direction 36, which is approximately perpendicular to the guiding direction 24, the fluidic chip 22 is fixed (or secured) within the chip holder.

Consequently, at the same time a fixation of the fluidic chip 22 within the chip holder 10 is achieved and a secure (sealed) fluidic coupling is established between the fluidic connection 34 and the fluid channel 50.

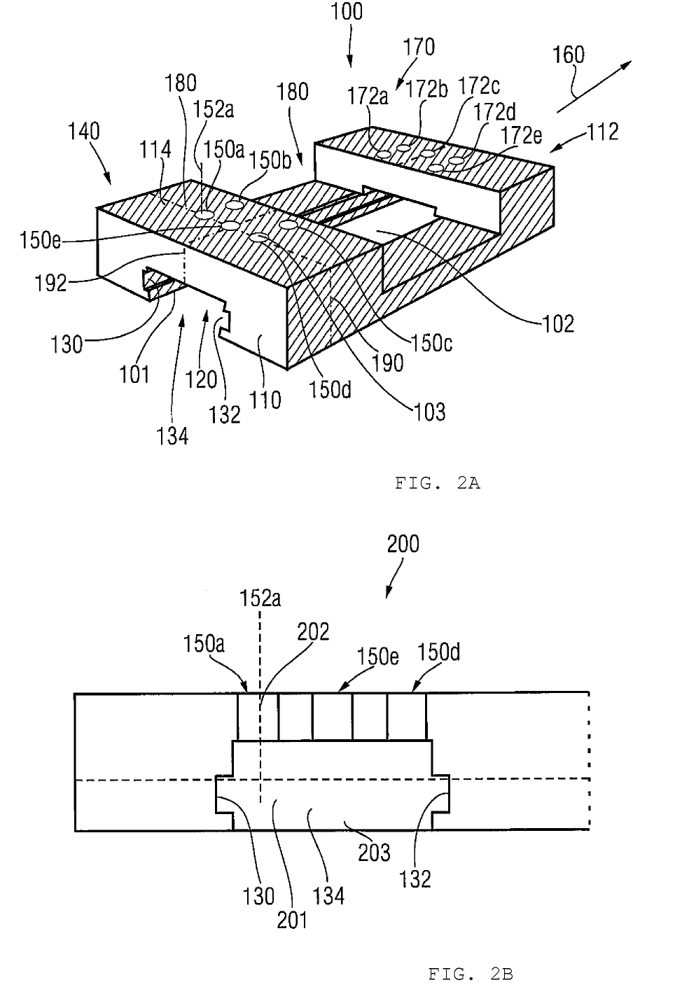

FIG. 2a shows a three-dimensional schematic representation of a chip holder according to the present invention. The chip holder of FIG. 2a is designated in its entirety with 100.

For the sake of explanation, a first surface 110 will subsequently be designated as a left surface. An opposing surface 112 (not visible in the given three-dimensional graphical representation) will be designated as a right surface. Moreover, a third surface 114 of the chip holder will subsequently be designated as a top surface. It should be noted here that the chip holder 100 generally comprises the shape of a cuboid, as such a shape minimizes the fabrication efforts. However, another shape of the chip holder could be utilized, as long as the specified functionality is fulfilled.

The chip holder 100 comprises a guide structure 120 extending from the first surface (or left surface) 110 to the second surface (or right surface) 112. However, it is sufficient if the guide structure extends from one surface of the chip holder 100 without reaching the opposite surface. The guide structure 120 comprises two parallel recesses 130, 132 arranged at two opposing bounding surfaces of an exemption 140. Thus, the two recesses 130, 132 form, when considered in combination with the exemption 134, a guide structure that is adapted to guide a fluidic chip, i.e. a substantially cuboidal object. The recesses 130, 132 extend outwardly toward the first surface 110, so that it is possible to insert the fluidic chip into the guide 120. Moreover, the recesses 130, 132 are adapted such that the fluidic chip (i.e. the cuboidal object) can be slid into the chip holder, i.e. inwardly when seen from the first surface 110 of the chip holder 100.

The chip holder 100 further comprises a carrying structure 140 mechanically connecting the pieces of material carrying the recesses 130, 132. The carrying structure also bounds the exemption 134 on at least three sides.

The carrying structure 140 further comprises a plurality of threaded holes 150a, 150b, 150c, 150d, 150e. The first threaded hole 150a is arranged such that an axis 152a of the first threaded hole 150a is approximately perpendicular to a guiding direction 160, the guiding direction being defined as a direction in which the fluidic chip can be slid into the chip holder 100 or out of the chip holder 100 along the guide 120. In other words, the guiding direction 160 is approximately determined by the direction of the recesses 130, 132. Moreover, it should be noted that an angle between the axis 152a of the first threaded hole 150 and the guiding direction 160 may deviate from 90° by +45°.

However, the deviation may be less than 20°.

Moreover, it should be noted that the first threaded hole 150a is arranged such that the axis 152a of the first threaded hole 150a crosses the region between the first recess 130 and the second recess 132, where the fluidic chip is positioned when the fluidic chip is slid into the chip holder.

Is should be noted here that a similar arrangement also holds for the second threaded hole 150b, the third threaded hole 150c, the fourth threaded hole 150d and the fifth threaded hole 150e. In other words, the axes of the threaded holes 150b, 150c, 150d, 150e are advantageously arranged to be perpendicular to the guiding direction 160 (or deviate from the perpendicular direction by no more than 45°). Also, axes of the threaded holes 150b, 150c, 150d, 150e are advantageously arranged such that the axes cross the region between the first recess 130 and the second recess 132, in which region the fluidic chip is arranged when the fluidic chip is slid into the chip holder.

Moreover, the chip holder 100 (optimally) comprises a second carrying structure 170 mechanically connecting the piece of material in which the first recess 130 is formed with the piece of material in which the second recess 132 is formed. It should be noted that the second carrying structure may also comprise threaded holes 172a, 172b, 172c, 172d, 172e. The threaded holes 172a, 172b, 172c, 172d, 172e may have the same alignment and functionality as described with respect to the threaded holes 150a, 150b, 150c, 150d, 150e.

It should be noted that fluidic connections can be inserted into the threaded holes 150a, 150b, 150c, 150d, 150e, 172a, 172b, 172c, 172d, 172e. The fluidic connections can be adjusted individually or independently.

Moreover, between the first carrying structure 140 and the second carrying structure 170 there is an exemption 180 allowing for an access to the fluidic chip when the fluidic chip is inserted into the chip holder 100. It is assumed that a first end portion of the fluidic chip is located such that at least an axis of one of the threaded holes 150a, 150b, 150c, 150d, 150e crosses the fluidic chip. Moreover, it is assumed that the fluidic chip, when inserted into the chip holder 100, is located such that at least one axis of the threaded holes 172a, 172b, 172c, 172d, 172e crosses a second end portion of the fluidic chip. Thus, a middle portion of the fluidic chip, when considered in the sliding direction 160, is located between the first carrying structure 140 and the second carrying structure 170. Thus, the exemption located between the first carrying structure 140 and the second carrying structure 170 is arranged such that access to at least surface of the fluidic chip (when inserted in the chip holder 100) is possible.

In order to give a more detailed and easily understandable overview of the inventive chip holder 100, FIG. 2b shows a cross-section 200 of the chip holder 100 in a plane designated in FIG. 2b by a dashed line designated with 190.

Moreover, in order to improve understanding, FIG. 2c shows a cross-section of the chip holder 100 including a fluidic chip. The cross-section of FIG. 2c is designated in its entirety with 250.

The fluidic chip is designated with 260. FIG. 2d shows another cross-section of the chip holder 100. The cross-section of FIG. 2d is designated in its entirety with 270.

The cross-section 270 shows a plane that is represented by a dash-dotted line 192 in FIG. 2a. In the cross-section 270 of FIG. 2d, the fluidic chip 260 is shown as extending from the first surface 110 of the chip holder 100 to the second surface 112 of the chip holder 100. However, the fluidic chip 260 may be longer or shorter than the extension between the first surface 110 and the second surface 112 of the chip holder 100. However, it should be noted that a portion of the chip holder being within the range of the first carrying structure 140 is designated to be a first end portion 280 of the fluidic chip. A portion of the fluidic chip lying in the range of the second carrying structure 170 is designated as a second end portion 282 of the fluidic chip. A portion of the fluidic chip lying between the first end portion 280 of the fluidic chip 260 and the second end portion 282 of the fluidic chip 260 (when seen in the direction 160) is designated as a middle portion 284 of the fluidic chip 260. It should be noted that the middle portion 284 of the fluidic chip can be accessed when the fluidic chip is inserted in the chip holder due to the presence of the recess or exemption 180. In other words, in an embodiment both a top surface 286 and a bottom surface 288 of the middle portion 284 of the fluidic chip 260 can be accessed, when the fluidic chip is inserted in the chip holder 100. Thus, any kind of measurement or sensing can be performed in the middle portion 284 of the fluidic chip 260. It should be noted here that typically a reaction chamber of the fluidic chip 260 is located in the accessible middle portion 284 of the fluidic chip 260. Thus, a maximum control of any reactions being executed in the reaction chamber can be exercised.

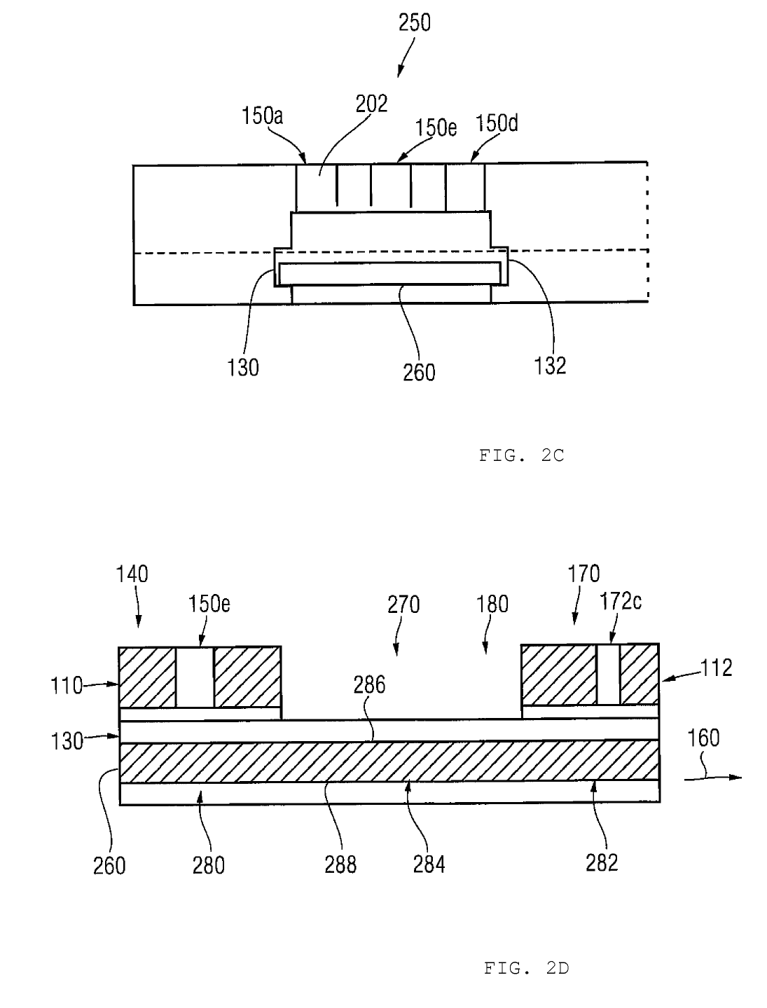

FIG. 3 shows a cross-section of an inventive fluid connection according to an embodiment of the present invention. The cross-section of FIG. 3 is designated in its entirety with 300. The cross-section 300 shows an adjustable connector 301 and a fluidic chip 302. The fluidic chip 302 comprises a fluid channel 304 and a connection portion 306. The connection portion 306 is in the form of a conical opening, the diameter of which is reducing (e.g. monotonically) in a direction from a top surface 308 of the fluidic chip 302 toward the inner part of the fluidic chip 302. In other words, the fluidic chip 302 comprises as a connection portion a conical opening reducing its diameter from the surface 308 of the fluidic chip toward the inner portion of the fluidic chip. The conical opening runs into the fluid channel 304. The fluidic connection 301 comprises a threaded bolt or screw 320. A pipe or capillary 322 extends through the threaded bolt or threaded screw 320 along an axis of the threaded bolt or threaded screw 320. Moreover, a sealing 324 (depicted here in solid black) is attached to a bottom surface 326 of the threaded bolt or threaded screw 320. Moreover, the pipe or capillary 322 extends into a central hole of the seal 324. The seal 324 comprises a conical shape, wherein a diameter of the seal 324 decreases outwardly from the surface 326 of the threaded bolt or threaded screw 320. Thus, the seal 324 is adapted to fit (at least partially) into the conical opening 306 of the fluidic chip 302. It should be noted that the threaded bolt or threaded screw is advantageously adapted such that turning the threaded bolt or threaded screw in a threaded hole (e.g. in one of the threaded holes 150a, 150b, 150c, 150d, 150e) in a predetermined fastening direction results in a force along an axis of the threaded bolt or threaded screw. Thus, when turning the threaded bolt or threaded screw, a force results pressing the threaded bolt or threaded screw (and, as a consequence, also the seal 324) toward the fluidic chip. Thus, by rotating the threaded bolt or threaded screw 320, the threaded bolt or threaded screw 320, as well as the seal 324 and the capillary 322, are moved and, when in contact, pressed, toward the fluidic chip 304. In contrast, by turning the threaded bolt or threaded screw 320 in a loosening direction, the threaded bolt or threaded screw 320 (and consequently, the seal 324 and the capillary 322) can be recessed away from the fluidic chip 302.

Thus, after the turning the threaded bolt or threaded screw in the loosening direction sufficiently, the fluidic connection 301 (consisting of the threaded bolt or threaded screw 320, the seal 324 and the capillary 322) does no longer interact with the fluidic chip. Thus, after loosening the threaded bolt or threaded screw, the fluidic chip can be removed by sliding the fluidic chip 302 in the sliding direction 160.

On the other hand, when a new fluidic chip 302 is to be inserted into the chip holder, the fluidic chip 302 can be first slid into an appropriate position, such that the recessed seal 324 is in a coarse alignment with the connection opening 306 of the fluidic chip. Subsequently, by turning the threaded bolt or threaded screw 320 in a fastening direction, the seal 324 is moved toward the fluidic chip 302. It is easily understandable that a fine alignment of the fluidic chip will automatically be achieved, provided the coarse alignment was sufficiently accurate such that the narrow end portion of the seal 324 enters the wide portion of the conical connection opening 306 of the fluidic chip 302. Thus, the inventive fluidic connection 301 allows both for a sealed connection between the capillary 322 and the fluid channel 304 of the fluidic chip 302 and for an automatic fine alignment of the fluidic chip 302 within the chip holder.

It should further be noted that the capillary 322 may end into a tube or pipe 340 providing an external fluidic connection.

It should be noted that the seal 324 may optionally be replaced by a seal of spherical shape.

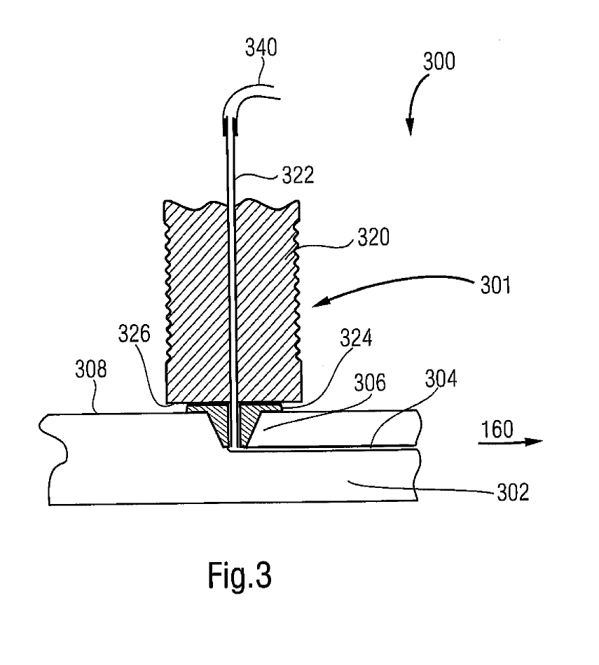

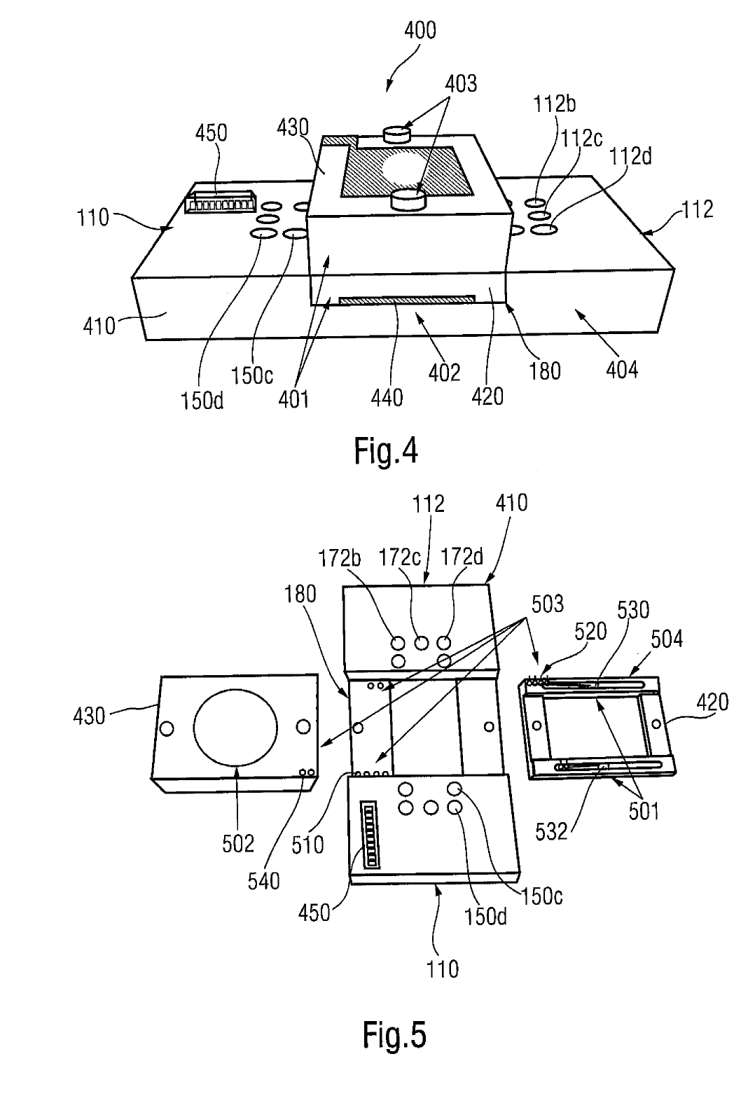

FIG. 4 shows a three-dimensional drawing of an inventive chip holder comprising two extension modules. The drawing of FIG. 4 is designated in its entirety with 400. It should be noted that the three-dimensional drawing 400 shows a chip holder 410, which is identical to the chip holder 100 shown in FIGS. 2a and 2b (without a fluidic chip), and also in FIGS. 2c and 2d (with an inserted fluidic chip). It should be noted here that means of the chip holder 410, which are identical to means of the chip holder 100, are designated with the same reference numerals in FIG. 4 and FIGS. 2a, 2b, 2c and 2d. However, it should be noted that the chip holder 410 is supplemented with respect to the chip holder 100. Two extension modules 420, 430 are attached to the chip holder 410 in the region of the exemption 180. The first extension module, which will be explained in more detail taking reference to FIG. 5, comprises for example one or more temperature sensors and provides an air gap for allowing an inflow or outflow of air heating or cooling the fluidic chip. The air gap is designated with 440.

It should be noted that advantageously the first extension module 420 is attached directly to the chip holder 410 making use of some fastening means. For example, the chip holder 410 may comprise at least one threaded hole, so that the first extension module 420 can be fixed to the chip holder 410 making use of a screw. In an alternative embodiment, the first extension module 420 may be fixed to the chip holder 410 making use of one or more electrical connectors. A holding force provided by the electrical connector may be sufficient to fix the first extension module 420 to the chip holder 410.

Moreover, a second extension module 430 is attached to the first extension module 420. Again, the second extension module 430 may be fixed to the first extension module 420 making use of any mechanical fastening means. Alternatively, the second extension module 430 may be fixed to the first extension module 420 making use of one or more electrical connectors connecting the second extension module 430 to the first extension module 420 both electrically and mechanically. Thus, the first extension module 420 and the second extension module 430 form a stack of extension modules.

It should further be noted that the second extension module 430 may also be fixed directly to the chip holder 410 (e.g. making use of a long screw, which may be reaching throughout the first extension module 420). In this case, it is not necessary that the first extension module 420 is fixed separately to the chip holder 410. In contrast, in this case, the first extension module 420 and the second extension module 430 are jointly fixed to the chip holder 410, the second extension module 430 pressing the first extension module 420 toward the chip holder 410.

It should also be noted that the second extension module 430 in an embodiment of the present invention comprises a fan for producing an airflow heating or cooling the fluidic chip.

Moreover, the chip holder 410 may comprise electrical connections. In an embodiment, the chip holder 410 comprises an electrical connector 450. Moreover, one or more electric cables are embedded into the chip holder, providing an electrical connection between the electrical connector 450 and another electrical connector placed in the vicinity of the exemption 180. The second electrical connector of the chip holder 410 is adapted to make an electrical connection with an extension module (e.g. the first extension module 420), when the extension module is attached to the chip holder 410.

Moreover, the first extension module 420 may for example comprise an electrical connector to be in electrical contact with the second electrical connector of the chip holder 410. Moreover, the first extension module 420 may comprise an additional electrical connector being arranged such that the additional electrical connector of the first extension module 420 is in electrical contact with an electrical connector of the second extension module 430, when the second extension module 430 is attached to the first extension module 420. Thus, the first extension module 420 may be adapted to route an electrical signal from the chip holder 410 to the second extension module 430.

FIG. 5 shows a three-dimensional drawing of the chip holder 410, wherein the first extension module 420 and the second extension module 430 are removed from the chip holder. It should be noted that same means are designated with same reference numerals in FIGS. 4 and 5. As can be seen from FIG. 5, the chip holder 410 comprises, arranged within the exemption 180, a plurality of electrical sockets 510 adapted to form an electrical contact with electrical pins. Moreover, the first extension module 420 comprises the plurality of electrical pins 520, which are in electrical contact with the sockets 510 of the chip holder 410, when the first extension module 420 is attached to the chip holder 410. It should be noted here that the first extension module 420 will be flipped along its longest axis by 180° (when compared to the position shown in FIG. 5) when the first extension module 420 is inserted into the chip holder 410. Moreover, it should be noted that the first extension module 420 comprises two sensors 530, 532 being arranged such that they are in direct contact with the fluidic chip, when the first extension module 420 and the fluidic chip are both inserted in the chip holder 410. Electrical connections of the sensors 530, 532 are connected to some of the pins of the first extension module 420.

Moreover, the second extension module 430 comprises two electrical pins 540, which are in electrical contact with electrical sockets of the first extension module 420, when the second extension module 430 is attached to the first extension module 420.

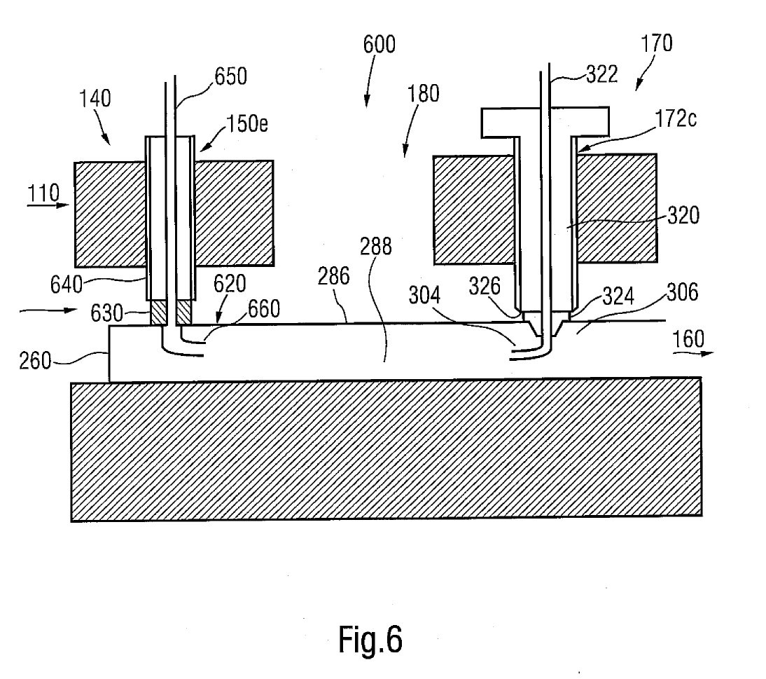

FIG. 6 shows a simplified cross-section through the chip holder 100 when a fluidic chip is inserted in the chip holder and the fluidic connections with the fluidic chip are established. It should be noted that same means are designated with same reference numerals in FIGS. 2a, 2b, 2c, 2d for the sake of providing a good overview. It should further be noted that the cross-sectional drawing of FIG. 6 is designated in its entirety with 600.

It should be noted that the cross-sectional drawing 600 shows two different types of fluidic connections. A first fluidic connection is inserted into the threaded hole 150e. A second fluidic connection is inserted into the second threaded hole 172c. The fluidic connection inserted into the second threaded hole 172c is identical to the fluidic connection shown in the graphical representation 300 of FIG. 3. Thus, it will not be explained here again. However, it should be noted that the second fluidic connection (inserted into the threaded hole 172c) makes use of a threaded screw having a hexagonal screw head, the hexagonal screw head allowing to turn the screw using a conventional tool.

The first fluidic connection inserted in the threaded hole 150e is similar to the fluidic connection inserted in the threaded hole 172c. However, a different type of sealing is used. It is assumed that at the position of the threaded hole 150e, the fluidic chip 260 comprises a flat (non-conical) fluidic opening 620. Accordingly, an elastomer O-ring or a flat ferrule 630 is used as a seal. The O-ring or flat ferrule 630 is pressed toward the fluidic chip 260 via a threaded bolt or threaded screw 640, when the threaded bolt or threaded screw 640 is fastened. Thus, the elastomer O-ring or flat ferrule 630 provides a sealing, so that a fluid can be exchanged between a capillary 650 extending along an axis of the threaded bolt or threaded screw 640 and a fluid channel 660 of the fluidic chip 260.

In the following, a brief summary of the present invention will be provided. The present invention provides an easy way of fixing a fluidic chip mechanically in the right position, and at the same time connecting the fluidic chip to tubes for supplying and removing fluids to and from the fluidic chip, using a pressurized flow. Therefore, the inventive structure (or chip holder) retains the chip and the tubes in a fixed position. Furthermore, a leakage-tight connection is maintained even at higher pressures (>5 MPa). The present invention provides a fixation and a high-pressure connection in one simple solution, minimizing an amount of adjustment needed when a chip is set up for usage.

The present invention uses the concept of applying a force downward upon a tubing connection, onto the microreactor chip. It should be noted that the way the downforce is applied can be varied. In the example, a fitting is screwed down into a threaded hole. By applying a downforce onto the fluidic chip, the chip itself is in this way immobilized in the right position. No further positioning means is needed. However, under some circumstances, extra positioning screws can be placed in unused fluidic connections (or unused threaded holes), providing extra accurate positioning. In an embodiment, the fluidic chip can be slid in (into the chip holder) from a left side 101 or from a right side 201 into the chip holder 404. According to an embodiment of the present invention, the chip holder can be made out of one piece, reducing production cost. Furthermore, according to an embodiment of the present invention, the design leaves a center part of the chip very open 102, enabling optical inspection and an addition of extra modules 401, 502, 504; 420, 430. In an embodiment, threaded holes are placed in the chip holder for holding the screws 103, 202. After the fluidic chip has been slid into the chip holder, the individual adjustable connectors 301 are screwed into the right holes, and are tightened one by one to the fluidic chip 302 to ensure the connection is leak-free for each connection. In an embodiment, the whole connection process takes only a few seconds. In an embodiment, the connections themselves can be inspected from an open left side and/or from an open right side for leakage 101, 201. If one connection fails or leaks, it can be replaced, again in a matter of a few seconds. If the fluidic chip has to be replaced, the connectors can be unscrewed a small amount, the chip can be slid out, and a new chip can be slid in. Then, the connections are reestablished by tightening the screws.

The present invention also provides an easy way to use different expansion elements 401, 420, 430, like lamps, sensors 501, 530, 532, fans 502, heating elements, peltier elements in a modular setup to the chip holder 404, 410, providing in addition a compact design for the whole setup. An arbitrary number of these expansion elements (also designated as extension elements) 401, 420, 430 can be combined in the setup depending on the experiment performed. If one of the expansion elements is a fan, the first expansion element 120 or the chip holder 410 has at least one gap 402, 440 at one or more sides to provide an airflow through the chip holder.

It should be noted that the size of the expansion elements (or extension elements) is more or less arbitrary. However, the size and the position of the connections may correspond between the chip holder and the expansion elements.

A way to electrically connect each expansion element with each other or with the chip holder would be the use of wires. However, this is unpractical and makes the system more error prone. An integration of the wires within each expansion element 420, 430 and the chip holder 410, and the connection of each extension element 420, 430 to the next extension element 420, 430 or to the chip holder 410 by electrically conducting plugs 503, 520, 510, 540 provides a more compact and elegant way.

If sensor elements are used, like for example sensors 501, 530, 532, the first expansion element 420, which is the nearest element to the fluidic chip 260, presses the sensor elements 530, 532 onto the fluidic chip. The expansion elements 520, 530 can be tightened by the electrical connections 503, 520, 510, 540 or by one or more screws 403. The sensors 501, 530, 532 can be attached to rubber feet 504 at the bottom of the first expansion element.

Beside, a (possibly transparent) heating foil on a glass plate or a plastic plate can be placed at the bottom of the chip holder 203 or a peltier element can be used as an expansion element to provide homogeneous heating or cooling of the fluidic chip.

In the following, reasonable margins of sizes and numbers will be described. It should be noted that the size of the chip in the chip holder is more or less arbitrary. However, the size and the position of the connections may correspond between the fluidic chip 260 and the chip holder 110, 410. As a minimum size for a chip connected by this concept, 8×8 mm can be considered reasonable. However, smaller chips may also be used. Moreover, there is no real maximum size. As a maximum, a largest size of commercially available glass or silicon wafers can be considered. However, larger fluidic chips could be used.

The number of connections is also arbitrary. In an embodiment, 10 connections are used.

The thickness of the chip and the corresponding slot size in the holder is also arbitrary. If only one single-level chip is used, the thickness advantageously lies between 0.5 mm and 3 mm. However, more than one chip can be bonded together, forming a stack of layers. There is no real maximum number, but a maximum thickness of 5 cm would still be practical.

It should also be noted that one embodiment of the present invention solves the general problem of fluidic interconnections that a connection has to be made between an end of a tube and a flat surface.

Several aspects of the present invention will subsequently be described. It should be noted that the present invention creates a chip holder. According to an embodiment of the present invention, the chip holder provides a fluidic connection between a fluidic chip and capillary tubing. According to another aspect of the present invention there is the possibility or option to connect modules (also designated as extension modules or expansion modules) to the chip holder.

According to an aspect of the invention, the chip holder consists of one piece of material apart from the O-rings and screws, and optional (electronic) modules (also designated as extension modules or expansion modules) discussed in the following. However, the chip holder does not need to consist of one part. Rather, in an embodiment the chip holder may consist of a plurality of parts. In other words, more parts are possible.

According to another aspect, the fluidic chip can be easily slid in from a side of the chip holder, which has sufficient space to accommodate chips which can vary slightly in size. According to another aspect of the present invention, the fluidic chip can easily be brought into the right position manually, or the positioning can be helped by the aid of a positioning pin and/or springs and/or extra holes in the fluidic chip. According to another aspect of the present invention, the fluidic chip is kept at the right position only be tightening the fluidic connections, or is additionally kept in the right position by pins, springs and/or dummy fittings. According to another aspect, the chip holder is designed in such a way that the fluidic connections themselves are easily accessible from the sides of the chip holder, enabling the user to check or adjust the connections. According to a further aspect, a fluidic connection is made, for instance by pressing an elastomer O-ring (or a plurality of O-rings or ferrules) or a flat ferrule, with the capillary through it, onto the flat fluidic chip. Each connection can be adjusted individually using screws with holes. According to another aspect, the fluidic part of the chip, containing the micromechanical components such as mixers, reaction channel, isolation devices, analysis channels, etc. is kept completely free at the top and the bottom. In this way, extra modules can be added very easily, and/or the chip can be optically inspected from both sides, and/or the fluidic connections can be checked.

According to another aspect, the dimensions of the fluidic chip and the chip holder, as well as the number of connections, are all arbitrary. According to another aspect, a (possibly transparent) heating foil on a glass plate or plastic plate, or a peltier element in the chip holder can be used to provide homogeneous heating or cooling of the fluidic chip.

Moreover, the present invention creates a modular setup. According to an aspect of the present invention, a modular expansion of the chip holder can be achieved by one or more expansion elements (or extension modules).

According to an aspect of the present invention, the expansion elements contain electronical, optical or mechanical elements like, for example, a temperature sensor, heaters, coolers, fans, spectroscopic probes, mechanical connectors to auxiliary equipment (e.g. sampling robots), lamps, etc., depending on the needs and circumstances.

According to an aspect of the invention, sensing elements, cooling elements or heating elements can be mechanically pressed onto the fluidic chip by the expansion elements.

According to an aspect of the invention, the dimensions of the expansions elements are arbitrary, but should fit the chip holder.

According to a further aspect of the present invention, the expansion elements are pluggable, enabling an arbitrary number of them to be plugged to each other and to the chip holder.

According to an aspect of the invention, one expansion element, the one that is mechanically connected to the chip holder, can be a “parent” element. That means, all electrical connections to external devices are placed on this element.

According to an aspect of the invention, electrical wires for signal transfer and/or power can be integrated in the expansion elements and the chip holder. The electrical connection between each expansion element and the first expansion element or the chip holder can be achieved by an arbitrary number of electrically conductive plugs, so that no external wires are needed to connect each expansion element to each other or to the chip holder.

According to an aspect of the invention, power and/or signal from one expansion element to the next expansion element can also be transferred by means of induction or by means of an antenna.

According to another aspect, the electrical plugs can also be used to position and fix the expansion elements to each other and to the chip holder, and to provide a firm connection.

According to an aspect of the invention, additional screws or other mechanical joining elements can be used to fix all the elements.

According to another aspect, if one of the expansion elements is a fan, the first expansion element or the chip holder has gaps at one or more sides to provide airflow through the chip holder.

To summarize the above, the present invention is described taking reference to a number of figures, wherein FIG. 1 shows a three-dimensional view of a chip holder, FIG. 2 shows a side view of the chip holder, FIG. 3 shows a cross-section of a screw-type connection, FIG. 4 shows a compact design of the microreactor chip holder with two expansion elements, and wherein FIG. 5 shows the expansion elements and the microreactor chip holder.

It should also be noted, that the above described chip holder can also be applied without making use of a guide being adapted such that the fluidic chip can be slid into the chip holder.

In other words, when using a modular chip holder setup, the fluidic connections can be designed arbitrarily. Also, the way and/or direction of inserting the fluidic chip into the modular setup can be chosen arbitrarily.

To summarize the above, the concept of using a modular setup (i.e. the concept of using a chip holder to which one or more extension modules can be attached such that the extension modules are in an optical, mechanical, electrical, magnetic, thermal or fluidic contact with the fluidic chip inserted in the chip holder) can be applied universally to various types of chip holders. A key idea of the modular setup is to provide access to the fluidic chip via an opening in the chip holder and also to provide an electrical connection between the chip holder and the extension module.

Moreover, it should be noted that any features described with respect to a chip holder having a guide for guiding a fluidic chip can also be applied to a chip holder not having such a guide. Also, features described with respect to a chip holder system comprising a chip holder with a guide can be applied also in a chip holder system comprising a chip holder without a guide.

It should be noted that the present invention creates a particularly reliable and easy to handle chip holder for a fluidic chip setup. Also, the present invention creates a modular chip holder setup.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

An embodiment of the present invention creates, a chip holder 10, 110; 410 for holding a fluidic chip 22; 260; 302, 306 and for providing a fluid connection to the fluidic chip. The chip holder may comprise a guide 20a, 20b; 130, 132, the guide being adapted such that the fluidic chip can be slid into the chip holder in a guiding direction 24, 160; and fastening means 30a; 150a, 150b, 150c, 150d, 150e, 172a, 172b, 172c, 172d, 172e, the fastening means being adapted to press a fluidic connection 34; 301; 630, 640 toward the fluidic chip, such that the fluidic chip is fixed within the chip holder, wherein the guide and the fastening means are adapted such that the guiding direction 34 and the direction, in which the fluidic connection is pressed, exhibit an angle in the range between 45° and 135°, including 45° and 135°.

The fastening means 30a; 150a, 150b, 150c, 150d, 150e, 172a, 172b, 172c, 172d, 172e may optionally be adapted to detachably press a seal 324; 630 toward the fluidic chip 22; 260; 302, 306, wherein the seal is adapted to avoid a leakage of a fluid connection between a pipe 322; 650 and a fluid channel 304; 660 within the fluidic chip, the pipe connecting the fluidic chip with a fluidic system external to the fluidic chip.

Further, the fastening means 30a may optionally comprise a threaded hole 150a, 150b, 150c, 150d, 150e, 172a, 172b, 172c, 172d, 172e and a threaded bolt or threaded screw 320; 640, wherein the threaded bolt or threaded screw comprises a fluid guide structure 322; 650 for guiding a fluid along an axis of the threaded bolt or threaded screw, wherein one end surface 326; 632 of the threaded bolt or threaded screw is adapted to press the seal 324; 630 toward the fluidic chip 22; 260; 302, 306, and wherein the seal is adapted such that a sealed fluid connection between the fluid guide structure and a fluid channel 304; 660 of the fluidic chip is established when the fastening means presses the seal toward the fluidic chip.

The chip holder may optionally comprise a plurality of fastening means for fastening a plurality of fluidic connections, and wherein the fastening means are adapted such that the connections can be adjusted individually.

The fluidic connection 34; 301 may optionally comprise a seal 324 having a conical shape, such that a diameter of the seal decreases in a direction toward the fluidic chip 22; 260; 302, 306; and wherein the seal is adapted to be inserted, at least partially, into a conical connection opening 306 of the fluidic chip.

The fastening means 30a; 150a, 150b, 150c, 150d, 150e, 172a, 172b, 172c, 172d, 172e, 320, 640 may optionally be adapted to press an O-ring or a flat ferrule 630 with a capillary 650 through the O-ring or through the flat ferrule toward the fluidic chip 22; 260; 302, 306.

Optionally, the fluidic connection 34; 301 may comprise a seal having a spherical shape.

Optionally, the fluidic connection 34; 301 may comprise a capillary 320; 650 extending through the fastening means 320; 640, and wherein the fastening means is adapted such that the capillary is in a sealed fluid connection with the fluidic channel 304; 660 of the fluidic chip, when the fastening means is pressed toward the fluidic chip 22; 260; 302, 306.

Optionally, the chip holder may further comprise at least one dummy fastening means, the dummy fastening means being adapted to be pressed toward the fluidic chip 22; 260; 302, 306, such that the fluidic chip is fixed within the chip holder, wherein the dummy fastening means is adapted to be replaceable with the fastening means for pressing the fluidic connection 34; 310 toward the fluidic chip.

Optionally, the guide 20a, 20b may comprise a slot 130, 132, the slot being adapted to guide the fluidic chip 22; 260: 302, 306.

Optionally, the guide 20a, 20b may comprise a first recess 130 for guiding a first edge of the fluidic chip 22; 260; 302, 306 and a second recess 132 for guiding a second edge of the fluidic chip, the second edge of the fluidic chip being arranged opposite to the first edge of the fluidic chip.

Optionally, the chip holder may adapt such that an optical inspection gap 265 remains between a surface 286 of the fluidic chip 22; 260; 302, 306 and a body of the chip holder, when the fluidic chip is inserted into the chip holder, wherein the optical inspection gap is arranged such that the fluidic connection 34; 301 can be inspected visually by an operator when the fluidic chip is inserted in the chip holder.

Optionally, the optical inspection gap 265 may be arranged to allow for an optical inspection of the fluidic connection 34; 301 along the guiding direction 24; 160.

Optionally, the chip holder 10; 110; 410 may be adapted to provide access to a portion 284 of the fluidic chip 22; 260; 302, 306, where no fluidic connections are present, when the fluidic chip is inserted in the chip holder.

Optionally, the chip holder 10; 110; 410 may comprise a module fastening means for detachably fastening an extension module 420, 430 to the chip holder, such that the extension module is in an optical, mechanical, electrical, magnetic, thermal or fluidic contact with the fluidic chip 22; 260; 302, 306, when the extension module is fastened to the chip holder and the fluidic chip is inserted in the chip holder.

Optionally, the chip holder and the module fastening means may be adapted to press the extension module 420; 430 toward the fluidic chip 22; 260; 302, 306, when the extension module is fastened to the chip holder and the fluidic chip is inserted in the chip holder.

Further, optionally the module fastening means may comprise an electrical connector 510, wherein the electrical connector is adapted to fasten the extension module 420 to the chip holder.

Optionally, the chip holder may further comprise an electrical loop or an electrical antenna adapted to transfer electrical power or electrical signals to the extension module.

Further, optionally the chip holder 10; 110; 410 may comprise electrical wiring adapted to provide a power supply connection or an information signal connection to a sensor or actuator 530, 532 within the fluidic chip 22; 260; 302, 306, within the chip holder or within an extension module 420, 430 attached to the chip holder.

Further, optionally the chip holder 10; 110; 410 may comprise a position pin being adapted to determine an end position of the fluidic chip within the chip holder.

Further, optionally the chip holder 10; 110; 410 may comprise a spring-loaded mechanism for locking the fluidic chip within the chip holder.

Further, optionally the chip holder 10; 110; 410 may comprise a heating foil arranged such that the fluidic chip 22; 260; 302, 306 is in a thermal contact with the heating foil when the fluidic chip is inserted in the chip holder.

Further, optionally the heating foil may be transparent.

Further, a fluidic system according to an embodiment of the invention may comprise the chip holder 10; 110; 410 and a fluidic chip 22; 260; 302, 306 inserted in the chip holder.

Further, a chip holder system according to an embodiment of the invention may comprise the chip holder 10; 110; 410 and an extension module 420; 430 attached to the chip holder such that the extension module is in contact with the fluidic chip 22; 260; 302, 306, when the fluidic chip is inserted in the chip holder.

Further, in the chip holder system, the chip holder 10; 110; 410 may optionally comprise an electrical connection means 510 to provide an electrical connection to the extension module, and the extension module 420 may optionally comprise an electrical connection means 520 to provide an electrical connection to the chip holder. The electrical connection means of the chip holder may be coupled with the electrical connection means of the extension module when the extension module is attached to the chip holder.

Further, the extension module 420 may optionally be adapted to be mechanically or magnetically coupled to the further extension module 430 to form a stack of at least two extension modules.

Further, the extension module 420 may optionally be adapted to route a signal from a first extension module connection means to a second extension module connection means, the first extension module connection means 520 being adapted to provide an electrical connection with the chip holder 10; 110; 410, the second extension module connection means may be adapted to provide an electrical connection with the further extension module 430.

Further, the extension module 420 may optionally comprise an electronic element, an optical element, a mechanical element, a sensor, an actuator, a pump, a heater, a cooler, a fan, a lamp, an optical analysis equipment and/or a mechanical probe handling means.

Further, an embodiment according to the invention creates a chip holder for holding a fluidic chip and for providing a fluidic connection to the fluidic chip, wherein the chip holder may comprise an opening to provide access to a portion of the fluidic chip where no fluidic connections are present, when the fluidic chip is inserted in the chip holder; and module fastening means for detachably fastening an extension module to the chip holder, such that the extension module is in an optical, mechanical, electrical, magnetic, thermal or fluidic contact with the accessible portion of the fluidic chip 22; 260; 302, 306, when the extension module is fastened to the chip holder, and when the fluidic chip is inserted in the chip holder.

Further, the chip holder may optionally comprise electrical connection means adapted to provide a detachable electrical connection between the chip holder and the extension module for exchanging energy and/or information between the chip holder and the extension module, when the extension module is attached to the chip holder.

Further, the chip holder may optionally comprise wireless transmission means for exchanging energy and/or information between the chip holder and the extension module, when the extension module is attached to the chip holder.

Further, the module fastening means may optionally be adapted to provide an electrical connection between the chip holder and the extension module.

Further, the module fastening means may optionally comprise an electrical connector.

Further, an embodiment according to the invention creates a chip holder system which may comprise a chip holder and an extension module 420 detachably attached to the chip holder using the fastening means, such that the extension module is in contact with the fluidic chip 22; 260, 302, 306, when the fluidic chip is inserted in the chip holder, wherein the extension module 420 may comprise electrical connection means 520 for establishing an electrical connection with the electrical connection means of the chip holder.

Further, the extension module 420 may adapt to be mechanically or magnetically coupled to the further extension module 430 to form a stack of at least two extension modules.

Further, the extension module 420 may adapt to route a signal from a first extension module connection means 520 to a second extension module connection means, the first extension module connection means 520 being adapted to provide an electrical connection with the chip holder, the second extension module connection means being adapted to provide an electrical connection with the further extension module 430.

1-37. (canceled)

38. A chip holder for holding a fluidic chip and for providing a fluid connection to the fluidic chip, the chip holder comprising:
a guide, the guide being adapted such that the fluidic chip can be slid into the chip holder in a guiding direction; and
a fastener, the fastener being adapted to press a fluidic connection toward the fluidic chip, such that the fluidic chip is fixed within the chip holder,
wherein the guide and the fastener are adapted such that the guiding direction and the direction, in which the fluidic connection is pressed, exhibit an angle in the range between 45° and 135°, comprising 45° and 135°, wherein the fastener comprises a threaded hole and a threaded bolt or threaded screw,
wherein the threaded bolt or threaded screw comprises a fluid guide structure for guiding a fluid along an axis of the threaded bolt or threaded screw,
wherein one end surface of the threaded bolt or threaded screw is adapted to press a seal toward the fluidic chip, and
wherein the seal is adapted such that a sealed fluid connection between the fluid guide structure and a fluid channel of the fluidic chip is established when the fastener presses the seal toward the fluidic chip.

39. The chip holder of claim 38, wherein the fastener is adapted to detachably press the seal toward the fluidic chip,
wherein the seal is adapted to avoid a leakage of a fluid connection between a pipe and a fluid channel within the fluidic chip, the pipe connecting the fluidic chip with a fluidic system external to the fluidic chip.

40. The chip holder of claim 38, wherein the chip holder comprises a plurality of fasteners for fastening a plurality of fluidic connections, and wherein the fasteners are adapted such that the connections can be adjusted individually.

41. The chip holder of claim 38, wherein the fluidic connection comprises a seal with a conical shape, such that a diameter of the seal decreases in a direction toward the fluidic chip; and
wherein the seal is adapted to be inserted, at least partially, into a conical connection opening of the fluidic chip.

42. The chip holder of claim 38, wherein the fastener is adapted to press an O-ring or a flat ferrule with a capillary through the O-ring or through the flat ferrule toward the fluidic chip.

43. The chip holder of claim 38, wherein the fluidic connection comprises a capillary extending through the fastener, and wherein the fastener is adapted such that the capillary is in a sealed fluid connection with the fluidic channel of the fluidic chip, when the fastener is pressed toward the fluidic chip.

44. The chip holder of claim 38, wherein the chip holder further comprises at least one dummy fastener, the dummy fastener being adapted to be pressed toward the fluidic chip, such that the fluidic chip is fixed within the chip holder, wherein the dummy fastener is adapted to be replaceable with the fastener for pressing the fluidic connection toward the fluidic chip.

45. The chip holder of claim 38, wherein the guide comprises a slot, the slot being adapted to guide the fluidic chip, or wherein the guide comprises a first recess for guiding a first edge of the fluidic chip and a second recess for guiding a second edge of the fluidic chip, the second edge of the fluidic chip being arranged opposite to the first edge of the fluidic chip.

46. The chip holder of claim 38, wherein the chip holder is adapted to provide access to a portion of the fluidic chip, where no fluidic connections are present, when the fluidic chip is inserted in the chip holder, and wherein the chip holder comprises a module fastener for detachably fastening an extension module to the chip holder, such that the extension module is in an optical, mechanical, electrical, magnetic, thermal or fluidic contact with the fluidic chip, when the extension module is fastened to the chip holder and the fluidic chip is inserted in the chip holder, and wherein the chip holder and the module fastener are adapted to press the extension module toward the fluidic chip, when the extension module is fastened to the chip holder and the fluidic chip is inserted in the chip holder.

47. A chip holder for holding a fluidic chip and for providing a fluidic connection to the fluidic chip, the chip holder comprising:
a holder for holding the chip within the chip holder;
an opening to provide access to a portion of the fluidic chip where no fluidic connections are present, when the fluidic chip is inserted in the chip holder; and
a module fastener for detachably fastening an extension module to the chip holder, such that the extension module is in an optical, mechanical, electrical, magnetic, thermal or fluidic contact with the accessible portion of the fluidic chip, when the extension module is fastened to the chip holder, and when the fluidic chip is inserted in the chip holder;
wherein the holder comprises a guide and a fastener;
wherein the guide is adapted such that the fluidic chip can be slid into the chip holder in a guiding direction; and
wherein the fastener is adapted to press a fluidic connection toward the fluidic chip, such that the fluidic chip is fixed within the chip holder,
wherein the guide and the fastener are adapted such that the guiding direction and the direction, in which the fluidic connection is pressed, exhibit an angle in the range between 45° and 135°, comprising 45° and 135°,
wherein the fastener comprises a threaded hole and a threaded bolt or threaded screw,
wherein the threaded bolt or threaded screw comprises a fluid guide structure for guiding a fluid along an axis of the threaded bolt or threaded screw,
wherein one end surface of the threaded bolt or threaded screw is adapted to press a seal toward the fluidic chip, and
wherein the seal is adapted such that a sealed fluid connection between the fluid guide structure and a fluid channel of the fluidic chip is established when the fastener presses the seal toward the fluidic chip.

48. A chip holder for holding a fluidic chip and for providing a fluid connection to the fluidic chip, the chip holder comprising:
a guide, the guide being adapted such that the fluidic chip can be slid into the chip holder in a guiding direction,
wherein the guide comprises two recesses; and
a fastener, the fastener being adapted to press a fluidic connection toward the fluidic chip, such that the fluidic chip is fixed within the chip holder, the fastener comprising holes,
wherein the guide and the fastener are adapted such that the guiding direction and the direction, in which the fluidic connection is pressed, exhibit an angle in the range between 45° and 135°, comprising 45° and 135°;
wherein the chip holder comprises a first carrying structure mechanically connecting pieces of material carrying the recesses, and
a second carrying structure mechanically connecting the piece of material in which the first recess is formed with the piece of material in which the second recess is formed;
wherein the carrying structures comprise the holes, into which the fluidic connections can be inserted;
wherein the chip holder comprises an exemption arranged between the first carrying structure and the second carrying structure and allowing for an access to the fluidic chip when the fluidic chip is inserted into the chip holder;
wherein the chip holder comprises a module fastener for detachably fastening an extension module to the chip holder in the region of the exemption, such that the extension module is in an optical, mechanical, electrical, magnetic, thermal or fluidic contact with the fluidic chip, when the extension module is fastened to the chip holder and the fluidic chip is inserted in the chip holder.

49. The chip holder according to claim 48, wherein the exemption is arranged to allow for an access to the middle portion of the fluidic chip when the fluidic chip is inserted in the chip holder.

50. The chip holder of claim 48, wherein the fastener is adapted to detachably press a seal toward the fluidic chip, wherein the seal is adapted to avoid a leakage of a fluid connection between a pipe and a fluid channel within the fluidic chip, the pipe connecting the fluidic chip with a fluidic system external to the fluidic chip.

51. The chip holder of claim 48, wherein the fastener comprises a threaded hole and a threaded bolt or threaded screw, wherein the threaded bolt or threaded screw comprises a fluid guide structure for guiding a fluid along an axis of the threaded bolt or threaded screw,
wherein one end surface of the threaded bolt or threaded screw is adapted to press the seal toward the fluidic chip, and
wherein the seal is adapted such that a sealed fluid connection between the fluid guide structure and a fluid channel of the fluidic chip is established when the fastener presses the seal toward the fluidic chip.

52. The chip holder of claim 48, wherein the chip holder comprises a plurality of fasteners for fastening a plurality of fluidic connections, and wherein the fasteners are adapted such that the connections can be adjusted individually.

53. The chip holder of claim 48, wherein the chip holder further comprises at least one dummy fastener, the dummy fastener being adapted to be pressed toward the fluidic chip, such that the fluidic chip is fixed within the chip holder, wherein the dummy fastener is adapted to be replaceable with the fastener for pressing the fluidic connection toward the fluidic chip.

54. The chip holder of claim 48, wherein the guide comprises a slot, the slot being adapted to guide the fluidic chip, or wherein the guide comprises a first recess for guiding a first edge of the fluidic chip and a second recess for guiding a second edge of the fluidic chip, the second edge of the fluidic chip being arranged opposite to the first edge of the fluidic chip.

55. The chip holder of claim 48, wherein the chip holder is adapted such that an optical inspection gap remains between a surface of the fluidic chip and a body of the chip holder, when the fluidic chip is inserted into the chip holder, wherein the optical inspection gap is arranged such that the fluidic connection can be inspected visually by an operator when the fluidic chip is inserted in the chip holder, and wherein the optical inspection gap is arranged to allow for an optical inspection of the fluidic connection along the guiding direction.

56. The chip holder of claim 48, wherein the chip holder and the module fastener are adapted to press the extension module toward the fluidic chip, when the extension module is fastened to the chip holder and the fluidic chip is inserted in the chip holder.

57. The chip holder of claim 48, wherein the module fastener comprises an electrical connector, wherein the electrical connector is adapted to fasten the extension module to the chip holder.

58. The chip holder of claim 48, wherein the chip holder comprises electrical wiring adapted to provide a power supply connection or an information signal connection to a sensor or actuator within the fluidic chip, within the chip holder or within an extension module attached to the chip holder.

59. A chip holder system:
a chip holder for holding a fluidic chip and for providing a fluid connection to the fluidic chip, the chip holder comprising:
a guide, the guide being adapted such that the fluidic chip can be slid into the chip holder in a guiding direction,
wherein the guide comprises two recesses; and
a fastener, the fastener being adapted to press a fluidic connection toward the fluidic chip, such that the fluidic chip is fixed within the chip holder, the fastener comprising holes,
wherein the guide and the fastener are adapted such that the guiding direction and the direction, in which the fluidic connection is pressed, exhibit an angle in the range between 45° and 135°, comprising 45° and 135°;
wherein the chip holder comprises a first carrying structure mechanically connecting pieces of material carrying the recesses, and
a second carrying structure mechanically connecting the piece of material in which the first recess is formed with the piece of material in which the second recess is formed;
wherein the carrying structures comprise the holes, into which the fluidic connections can be inserted;
wherein the chip holder comprises an exemption arranged between the first carrying structure and the second carrying structure and allowing for an access to the fluidic chip when the fluidic chip is inserted into the chip holder;
wherein the chip holder comprises a module fastener for detachably fastening an extension module to the chip holder in the region of the exemption, such that the extension module is in an optical, mechanical, electrical, magnetic, thermal or fluidic contact with the fluidic chip, when the extension module is fastened to the chip holder and the fluidic chip is inserted in the chip holder; and
an extension module attached to the chip holder such that the extension module is in contact with the fluidic chip, when the fluidic chip is inserted in the chip holder.

60. The chip holder system of claim 59, wherein the extension module is adapted to be mechanically or magnetically coupled to the further extension module to form a stack of at least two extension modules.

61. A chip holder for holding a fluidic chip and for providing a fluidic connection to the fluidic chip, the chip holder comprising:
a holder for pressing fluidic connections toward the fluidic chip to hold the chip within the chip holder;
an opening arranged between a first holder and a second holder to provide access to a middle portion of the fluidic chip where no fluidic connections are present, when the fluidic chip is inserted in the chip holder; and
a module fastener for detachably fastening an extension module to the chip holder in a region of the opening, such that the extension module is in an optical, mechanical, electrical, magnetic, thermal or fluidic contact with the accessible portion of the fluidic chip, when the extension module is fastened to the chip holder, and when the fluidic chip is inserted in the chip holder.

62. The chip holder of claim 61, comprising an electrical connector adapted to provide a detachable electrical connection between the chip holder and the extension module for exchanging energy and/or information between the chip holder and the extension module, when the extension module is attached to the chip holder.
